(19) United States
(12) Patent Application Publication
(10) Pub. No.: US 2006/0271430 A1
(43) Pub. Date: Nov. 30, 2006

(54) Storage Container Advertising Method

(76) Inventor: Bradley L. Gotfried, Sai Kung (HK)

Correspondence Address: AKERMAN SENTERFITT, P.O. BOX 3188, WEST PALM BEACH, FL, 33402-3188, US

(21) Appl. No.: 11/380,845

(22) Filed: Apr. 28, 2006

Related U.S. Application Data
(63) Continuation of application No. 10/281,611, filed on Oct. 28, 2002, now abandoned.

(51) Int. Cl. G07G 1/14

(52) U.S. Cl. 705/14

(57) ABSTRACT

A method of generating advertising revenue includes purchasing from a prior owner a portable display structure having at least one advertising surface for displaying at least one advertisement, leasing the portable display structure to the prior owner, and selling at least a portion of the advertising surface to at least one advertiser thereby providing the at least one advertiser with an advertising medium. The at least one advertiser can include a prior owner and a third party. The portable display structure can be a transportation vehicle for transporting goods or passengers.

### CROSS REFERENCE TO RELATED APPLICATIONS

This application is a continuation of U.S. patent application Ser. No. 10/281,611, filed Oct. 28, 2002, the entirety of which is herein incorporated by reference.

### STATEMENT REGARDING FEDERALLY SPONSORED RESEARCH OR DEVELOPMENT

(Not Applicable)

### BACKGROUND OF THE INVENTION

1. Technical Field

The present invention relates to methods of generating advertising revenue, and more particularly to methods that generate advertising revenue from portable advertising display structures.

2. Description of Related Art

While significant advertising revenues are earned from traditional advertising mediums such as television and radio, advertisers are constantly seeking new and effective mediums for reaching consumers. For example, with the introduction of an interstate highway system in the United States, advertisers were given an opportunity for a new medium of advertising to consumers who were traveling along such expressways. In response, advertisers used billboards to display advertisements on the side of highways. While billboards provided advertisers with a structure to display their advertisements, billboards have features that do not allow for optimal advertising. For example, a billboard is stationary and has limited viewing range. Additionally, billboards are typically static advertisements and do not allow for dynamic advertising.

To overcome the disadvantages of billboards, many companies began to utilize transportation vehicles as advertising mediums. While this innovative method of using vehicles for advertising has benefited a few resourceful entities, there still exists space for growth in the mobile advertising arena. Specifically, owners of vehicles may not have the resources, business skills, or contacts necessary to take full advantage of potential advertising mediums and enter into complex advertising agreements.

### SUMMARY OF THE INVENTION

The invention relates to a method of generating advertising revenue. The method includes purchasing from a prior owner a portable display structure having at least one advertising surface for displaying at least one advertisement, leasing the portable display structure to the prior owner, and selling at least a portion of the advertising surface to at least one advertiser, thereby providing the at least one advertiser with an advertising medium. The at least one advertiser can include a prior owner and a third party. In one arrangement, the portable display structure can include a transportation vehicle for transporting at least one of goods and passengers. The transportation vehicle can be a trailer in which the at least one advertising surface for displaying the at least one advertisement can be part of the trailer. Additionally, the transportation vehicle can be a railway car in which the at least one advertising surface for displaying the at least one advertisement can be part of the railway car.

In another arrangement, the at least one advertising surface for displaying the at least one advertisement can include an electronic display system in which the electronic display system can display at least one pre-programmed advertisement. Furthermore, the at least one advertising surface for displaying the at least one advertisement can include an alternating display mechanism. The alternating display mechanism can display at least two advertisements on an alternating basis. In another arrangement where the at least one advertiser purchases a plurality of portions of the advertising space, the method can include a step of rewarding the at least one advertiser with a reduced sale price.

In another arrangement, a method of generating advertising revenue includes purchasing from a prior owner a transportation vehicle having a trailer for transporting goods where the trailer has at least one advertising surface for displaying at least one advertisement. This arrangement also includes leasing the transportation vehicle to the prior owner and selling at least a portion of the at least one advertising surface to at least one advertiser, thereby providing the at least one advertiser with an advertising medium.

### BRIEF DESCRIPTION OF THE DRAWINGS

The invention may be better understood by referring to the following description taken in conjunction with the accompanying drawings, it being understood, however, that the invention is not limited to the precise arrangements and instrumentalities shown.

FIG. 1 illustrates a method for generating advertising revenue in accordance with the inventive arrangements.

FIG. 2 illustrates a flow chart of the method of FIG. 1 for generating advertising revenue in accordance with the inventive arrangements.

FIG. 3 illustrates one embodiment of a portable display structure in accordance with the inventive arrangements.

FIG. 4 illustrates one embodiment of an advertising surface for displaying advertisements in accordance with the inventive arrangements.

FIG. 5 illustrates another embodiment of an advertising surface for displaying advertisements in accordance with the inventive arrangements.

### DETAILED DESCRIPTION OF THE PREFERRED EMBODIMENTS

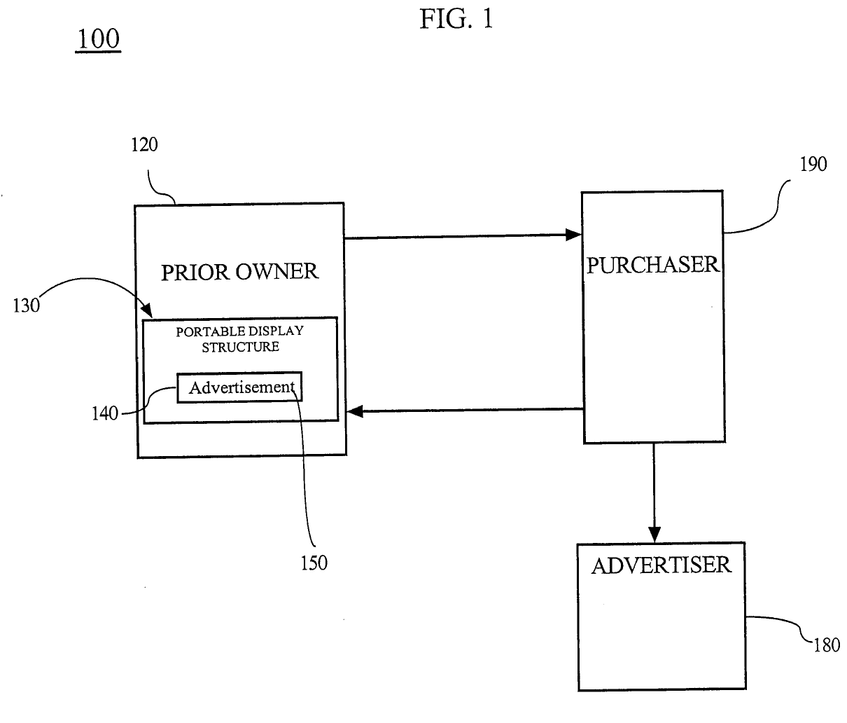

Referring to FIG. 1, a method 100 for generating advertising revenue in accordance with the inventive arrangements is illustrated. The method 100 includes a purchaser 190 purchasing from a prior owner 120 a portable display structure 130 having at least one advertising surface 140 for displaying at least one advertisement 150. Additionally, the method 100 includes the steps of the purchaser 190 leasing the portable display structure 130 to the prior owner 120 and selling at least a portion of the advertising surface 140 to at least one advertiser 180 thereby providing an advertising medium to the advertiser 180.

As defined herein, the prior owner 120 can be an individual or any entity with an ownership interest in the portable display structure 130 from whom the purchaser 190 purchases the portable display structure 130. The purchaser 190 can be any individual or entity who pays the prior owner 120 for an ownership interest in the portable display structure 130 and sells at least a portion of the advertising surface 140 to an advertiser 180. As an example, the purchaser 190 can be an advertising agency that can lease or sell at least a portion of the advertising surface 140 of the portable display structure 130 to its clients. Additionally, the at least one advertiser 180 can include the prior owner 120 or a third party (not shown). Therefore, the purchaser 190 can purchase 110 the portable display structure 130 from the prior owner 120, lease the portable display structure 130 back to the prior owner 120, and also sell the advertising surface 140 to the prior owner 120 or a third party. For purposes of the invention, a third party can be any individual or entity capable of purchasing advertising space.

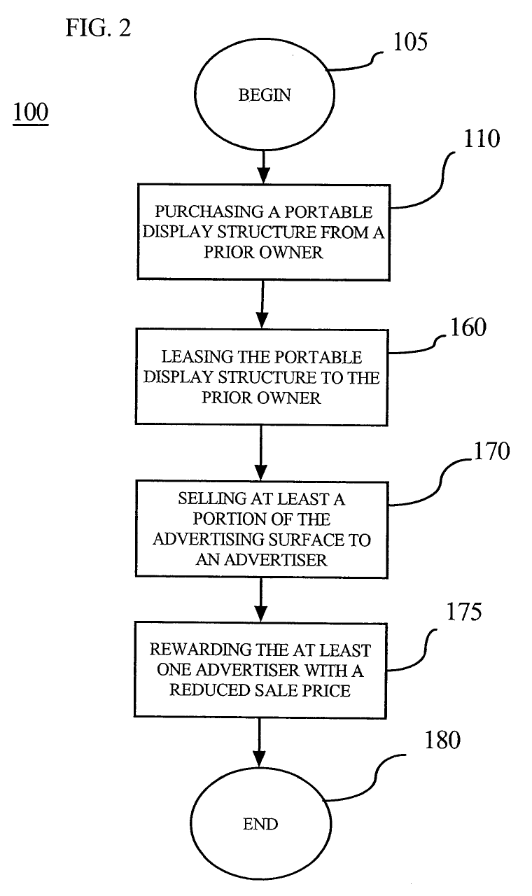

An illustrative example of the method 100 in operation is shown in FIG. 2. The method 100 can begin at step 105. As shown at step 110, a portable display structure having at least one advertising surface for displaying at least one advertisement can be purchased from the prior owner. At step 160 the portable display structure can be leased back to the prior owner. At least a portion of the advertising surface can be sold to at least one advertiser thereby providing the at least one advertiser with an advertising medium, as shown at step 170. The method 100 can end at step 180. Although FIG. 2 illustrates the steps of method 100 in a particular order, the invention is not limited in this regard, as any other suitable order of the steps may be used.

In another arrangement where the at least one advertiser purchases a plurality of portions of the advertising space, the method can also include a step 175 of rewarding the advertiser with lower selling prices. For example, in order to induce sales, the advertiser can be given different advertising space selling prices dependent on the amount of advertising spaces sold to that advertiser. With more advertising spaces being sold to a particular advertiser, the prices of each individual advertising space will be accordingly reduced, thus giving the advertiser an incentive to purchase high volumes of advertising space.

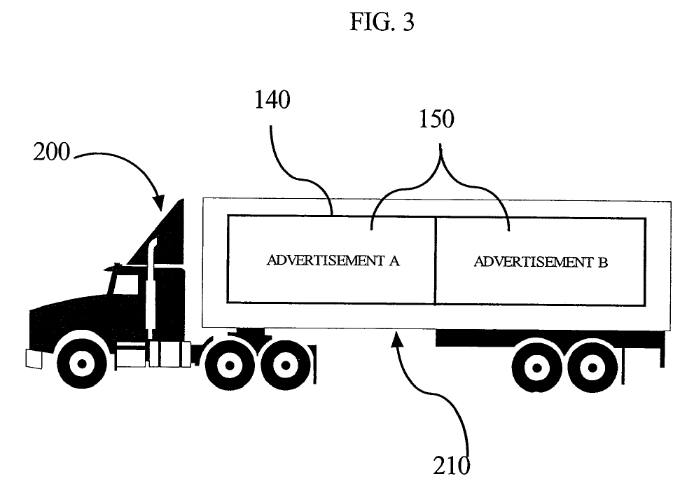

In one arrangement, the portable display structure 130 (see FIG. 1) can be a transportation vehicle for transporting goods, passengers or a combination thereof. Referring to FIG. 3, an example of a transportation vehicle 200 that can be used with the method 100 is shown. The transportation vehicle 200 can include, for example, a trailer 210 having at least one advertising surface 140 for displaying the at least one advertisement 150. As shown, the at least one advertising surface 140 can be part of the trailer 210. It is understood, however, that the portable display structure (see FIG. 1) is not limited to this example, as any other suitable transportation vehicle can be used with the method 100. For example, the transportation vehicle can also be a railway car (not shown) having at least one advertising surface. In fact, the portable display structure is not limited to a transportation vehicle, as any other portable device having at least one advertising surface can be used with the invention. Such other portable devices having at least one advertising surface can include hot air balloons, portable billboards, and portable storage containers.

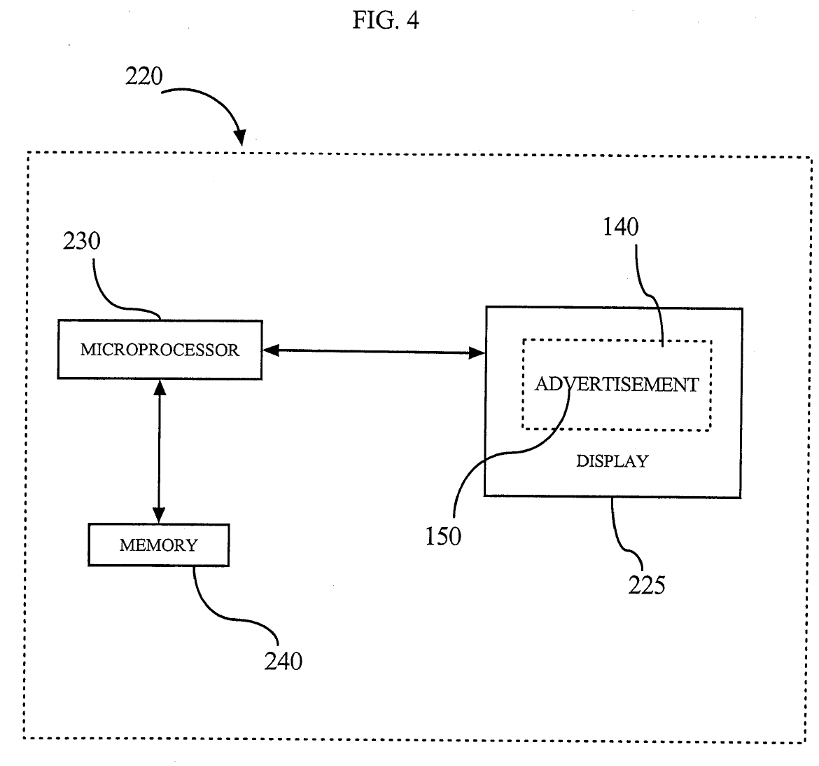

Referring back to FIG. 1, the at least one advertising surface 140 for displaying the at least one advertisement 150 can include any surface suitable for displaying an advertisement, including the side of a trailer as discussed earlier (see FIG. 3). The invention is not limited in this regard, however, as other suitable surfaces may be used. For example, the at least one advertising surface 140 can be part of an electronic display system 220, as illustrated in FIG. 4. The electronic display system 220 can include a display 225 having the advertising surface 140, a microprocessor 230 and memory 240, and can display at least one pre-programmed advertisement 150. One or more of these pre-programmed advertisements 150 can be stored in memory 240 for later retrieval by the microprocessor 230. The microprocessor 230 can transmit these pre-programmed advertisements 150 to the display 225, where they can be displayed on the advertising surface 140. In this arrangement, the advertising surface 140 can include any suitable structure for displaying the pre-programmed messages, such as an array of light emitting diodes, an array of light bulbs, or a liquid crystal display panel.

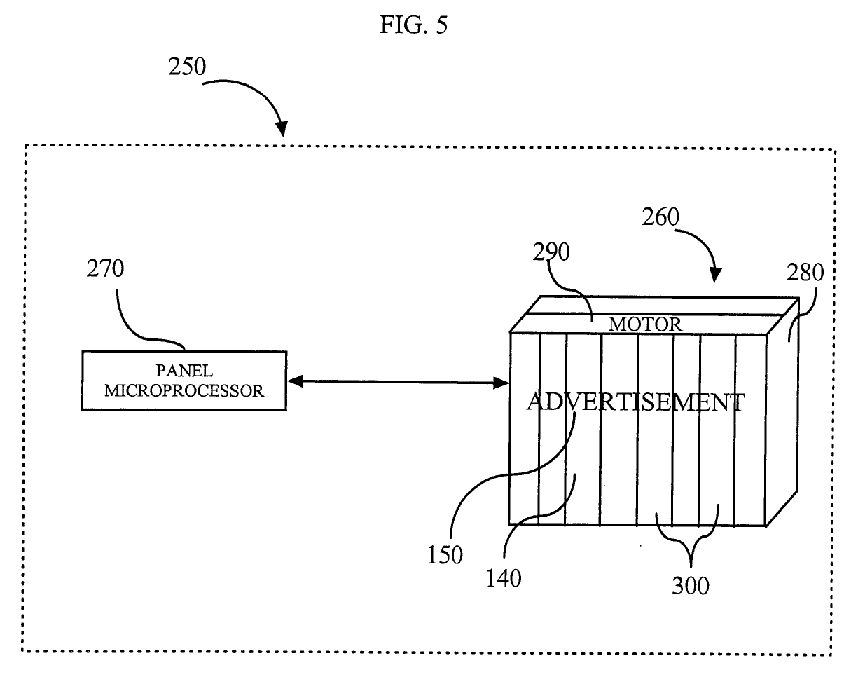

In another arrangement, the at least one advertising surface 140 can be part of an alternating display system 250, as shown in FIG. 5. The alternating display system 250 can include an alternating display mechanism 260 and a panel microprocessor 270. The panel microprocessor 270 can control the operation of the alternating display mechanism 260. The alternating display mechanism 260 can include a frame 280 and a motor 290. The alternating display mechanism 260 can also include a plurality of panels 300, which can be rotatably coupled to the frame 280. In addition, the motor 290 can control the rotation of the panels 300.

One or more of the panels 300 can have at least two sides (not shown) capable of being displayed. Specifically, each side of each panel 300 can combine with other sides of other panels 300 to form the advertising surface 140 for displaying an advertisement 150. The number of sides each panel 300 contains can determine the number of advertisements 150 (and advertising surfaces 140) to be alternately displayed. For example, if each panel 300 contains two sides, then two advertisements 150 can be alternately displayed.

To alternate the display of the advertisements 150, the panel microprocessor 270 can signal the motor 290 to rotate one or more of the panels 300. Once completed, the panels 300 form the advertising surface 140 onto which the advertisement 150 can be displayed. The cycle can be repeated to enable the display of as many advertisements 150 as desired. Of course, the advertising surfaces 140 described in relation to FIG. 5 is merely an example, and it is understood that any other suitable system having an advertising surface can be used with the inventive method.

Although the present invention has been described in conjunction with the embodiments disclosed herein, it should be understood that the foregoing description is intended to illustrate and not limit the scope of the invention as defined by the claims.

What is claimed is:

1. A method of generating advertising revenue, comprising the steps of:
purchasing from a prior owner a portable display structure having at least one advertising surface for displaying at least one advertisement;
leasing the portable display structure to the prior owner;
selling at least a portion of the advertising surface to at least one advertiser thereby providing the at least one advertiser with an advertising medium; and
wherein the portable display structure comprises a transportation vehicle for transporting at least one of goods and passengers.

2. The method according to claim 1, wherein the at least one advertiser includes a prior owner.

3. The method according to claim 1, wherein the at least one advertiser includes a third party.

4. The method according to claim 1, wherein the transportation vehicle comprises a trailer;
wherein the at least one advertising surface for displaying the at least one advertisement is part of the trailer.

5. The method according to claim 1, wherein the transportation vehicle comprises a railway car;
wherein the at least one advertising surface for displaying the at least one advertisement is part of the railway car.

6. The method according to claim 1, wherein the at least one advertising surface for displaying the at least one advertisement comprises an electronic display system;
wherein the electronic display system displays at least one pre-programmed advertisement.

7. The method according to claim 6, wherein the at least one advertising surface for displaying the at least one advertisement comprises an alternating display mechanism;
wherein the alternating display mechanism displays at least two advertisements on an alternating basis.

8. The method according to claim 6, where the at least one advertiser purchases a plurality of portions of the advertising space, further comprising the step of rewarding the at least one advertiser with a reduced sale price.

9. A method of generating advertising revenue, comprising the steps of:
purchasing from a prior owner a portable display structure having at least one advertising surface for displaying at least one advertisement;
leasing the portable display structure to the prior owner;
selling at least a portion of the advertising surface to at least one advertiser thereby providing the at least one advertiser with an advertising medium; and
wherein the at least one advertising surface for displaying the at least one advertisement comprises an electronic display system;
wherein the electronic display system displays at least one pre-programmed advertisement.

10. The method according to claim 9, wherein the at least one advertising surface for displaying the at least one advertisement comprises an alternating display mechanism;
wherein the alternating display mechanism displays at least two advertisements on an alternating basis.

11. The method according to claim 9, where the at least one advertiser purchases a plurality of portions of the advertising space, further comprising the step of rewarding the at least one advertiser with a reduced sale price.

12. A method of generating advertising revenue, comprising the steps of:
purchasing from a prior owner a transportation vehicle having a trailer for transporting goods;
wherein the trailer has at least one advertising surface for displaying at least one advertisement;
leasing the transportation vehicle to the prior owner; and
selling at least a portion of the at least one advertising surface to at least one advertiser thereby providing the at least one advertiser with an advertising medium.

13. The method according to claim 12, wherein the at least one advertiser includes a prior owner.

14. The method according to claim 12, wherein the at least one advertiser includes a third party.
